(19) United States
(12) Patent Application Publication
(10) Pub. No.: US 2004/0258367 A1
(43) Pub. Date: Dec. 23, 2004

(54) Electrooptical module

(76) Inventors: Martin Weigert, Berlin (DE); Bemhard Bachl, Falkensee (DE); Ralf Ehrlich, Teltow (DE); Gregor Ploger, Berlin (DE)

Correspondence Address: ESCHWEILER & ASSOCIATES, LLC, NATIONAL CITY BANK BUILDING, 629 EUCLID AVE., SUITE 1210, CLEVELAND, OH, 44114, US

(21) Appl. No.: 10/811,102

(22) Filed: Mar. 26, 2004

(30) Foreign Application Priority Data
Mar. 27, 2003 (DE) 103 14 494.3

(51) Int. Cl. G02B 6/36

(52) U.S. Cl. 385/89

(57) ABSTRACT

The present invention relates to an electrooptical module that efficiently employs optical bandwidth. The invention includes two or electrooptical components that are in an optical free-beam connection with an optical waveguide using at least one respective lens.

The invention relates to an electrooptical module for connection to at least one optical waveguide with at least two electrooptical components.

An electrooptical module of this type is known from the international laid-open patent specification WO 99/29000. The previously known electrooptical module has a multiplicity of vertically emitting lasers, which are arranged in a row. Each laser—with the exception of two “marginal lasers” respectively located at the outer margin of the row—is respectively assigned an optical waveguide, into which the radiation of the assigned vertically emitting laser is coupled.

The invention is based on the object of providing an electrooptical module in which the optical bandwidth of the optical waveguide or waveguides can be utilized even better than before.

On the basis of an electrooptical module of the type specified at the beginning, this object is achieved according to the invention by the defining features of claim 1. Advantageous configurations of the invention are specified in subclaims.

It is accordingly provided by the invention that the at least two electrooptical components are in an optical free-beam connection with the same optical waveguide by means of at least one lens in each case.

It is to be regarded as a major advantage of the electrooptical module according to the invention that a number of electrooptical components, for example lasers, are connected to one and the same optical waveguide. The optical waveguide can consequently transmit the optical signals of at least two electrooptical components, whereby the optical bandwidth of the optical waveguide is utilized particularly well.

A further major advantage of the electrooptical module according to the invention is that a direct optical connection between the electrooptical components and the optical waveguide is realized on the basis of the optical free-beam connection brought about by the lenses. Consequently, on account of the free-beam connection, it is possible in the case of the electrooptical module according to the invention to dispense for example with the use of “fiber combiners”, which are known in the area of WDM (Wavelength Division Multiplex) components and with which a bringing together of optical signals of different electrooptical components into a single optical waveguide is achieved.

To permit particularly simple assembly of the electrooptical module, it is regarded as advantageous if the optical imaging of at least one optical lens has an optical “squint angle”. A “squint angle” is understood here as meaning that an angle other than 180° occurs between the optical axis of the incident light and the optical axis of the emergent light; on account of the squint angle, the light is “refracted away” from the optical axis after passing through the lens. A major advantage of the presence of the squint angle in the case of at least one of the lenses is that the electrooptical components can be arranged next to one another—for example on a carrier—while the capability of the components arranged next to one another to couple the light into one and the same optical waveguide is nevertheless ensured.

To achieve the effect that the optical free-beam connection between the optical waveguide on the one hand and the electrooptical components on the other hand is comparable for all the electrooptical components, or substantially identical, it is regarded as advantageous if the at least two electrooptical components are arranged symmetrically with respect to their connection to the optical waveguide and if the lenses of the at least two electrooptical components respectively have the same optical squint angle. In the case of such a symmetrical arrangement, the optical free-beam connection between each of the electrooptical components and the optical waveguide is consequently largely identical.

Particularly low-cost assembly of the electrooptical module can be achieved if the electrooptical components are arranged on a common carrier, because it is then possible to use for example the automatic pick-and-place machines known from printed circuit board technology for the assembly of the module. The adjustment of the lenses can be achieved in a simple and consequently advantageous way if the lenses are arranged in such a way on a supporting element, or a respective supporting element, that is located on the carrier that they are located spatially over the electrooptical components assigned to them—in particular directly over them.

If the electrooptical module is to be used for emitting optical signals, it is regarded as advantageous if the at least two electrooptical components are lasers and/or light-emitting diodes.

The lasers and/or light-emitting diodes preferably have in this case different optical wavelengths, in order that the bandwidth of the assigned optical waveguide is optimally utilized.

The electrooptical module may preferably be a C-WDM module (C-WDM: coarse wavelength division multiplex) or a D-WDM module (D-WDM: dense wavelength division multiplex).

The electrooptical module may have, for example, four lasers and/or light-emitting diodes, which are assigned to one and the same optical waveguide and arranged symmetrically with respect to the optical waveguide. The lasers or light-emitting diodes are preferably arranged at the corner points of an imaginary or virtual square.

If at least one of the at least two electrooptical components is an edge-emitting laser, it is regarded as advantageous if the supporting element is reflective on its outer side facing the edge-emitting laser or its outer sides facing the edge-emitting lasers, the supporting element and the reflective outer sides being arranged in such a way that the light emitted by the edge-emitting laser or lasers is directed onto the respectively assigned lens.

Low-cost packages for electrooptical modules are, for example, the so-called TO packages; it is therefore regarded as advantageous if the electrooptical module is accommodated in a TO package and the lenses are respectively adjusted optically with respect to the window cap of the TO package.

The electrooptical module may be advantageously mounted on a flexible printed circuit board, in particular on a flexboard. The flexible printed circuit board is in this case preferably attached, in particular adhesively attached, on a printed circuit board carrier, which for the purposes of heat removal of the waste heat produced by the electrooptical components should have the greatest possible thermal conductivity. The printed circuit board carrier advantageously consists of metal, in particular aluminum, since material of this type has a particularly high thermal conductivity.

The electrical connection between the electrooptical module and the flexible printed circuit board may take place for example by means of bonding wires, which are attached between the electrooptical module and the flexible printed circuit board. Instead of bonding wires, other types of contacting are also possible.

The connection of the electrooptical module to one or more optical waveguides may take place directly in such a way that the optical waveguide or waveguides are permanently connected directly to the electrooptical module; instead, the electrooptical module may also be equipped with one or more optical plug-in devices (plugs/sockets), with which external optical waveguides can be connected to the electrooptical module. These optical plug-in devices may be, for example, so-called “receptacles”.

A permanent and direct connection between the optical waveguide or waveguides and the electrooptical module can be advantageously achieved by the optical waveguide or waveguides being led through a covering cap, with which the electrooptical module is sealed, in particular hermetically sealed.

The optical adjustment between the optical waveguide or the optical waveguides and the electrooptical module can be achieved by the covering cap being aligned in relation to the lenses of the electrooptical module in such a way that an optimal optical connection is achieved between the electrooptical components on the one hand and the optical waveguide or waveguides on the other hand.

The optical waveguide or the optical waveguides may advantageously be adhesively fixed in the covering cap, in order to achieve permanent and secure fixing of the optical waveguide or optical waveguides.

The covering cap may preferably be adhesively attached on the electrooptical module, in order to achieve a sealed, in particular hermetic, insulation of the electrooptical module.

The covering cap advantageously consists at least partly of silicon, since silicon is a low-cost material which can be worked relatively easily with the aid of the methods used for working semiconductors.

Instead, the covering cap may also be formed by an injection-molded part or a multi-layer ceramic component.

To explain the invention:

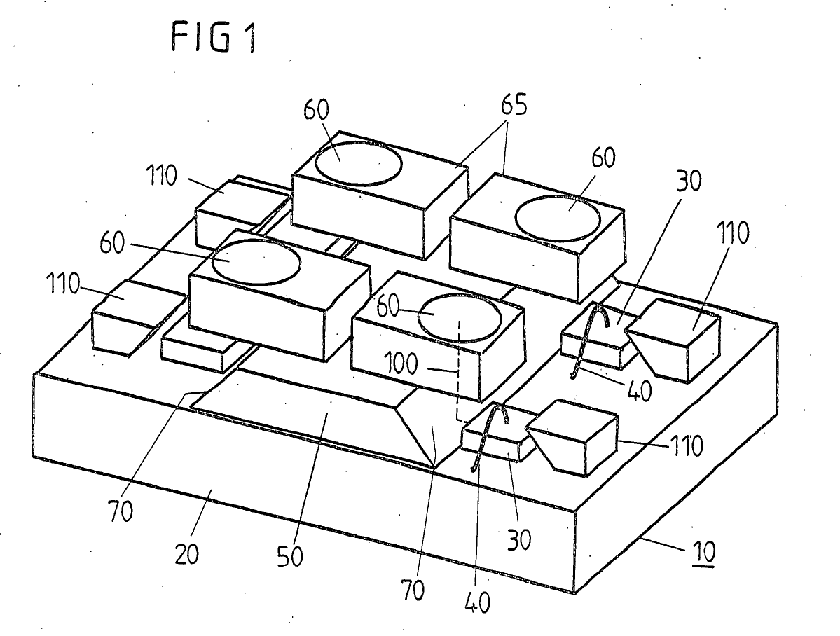

FIG. 1 shows an exemplary embodiment of an electrooptical module according to the invention,

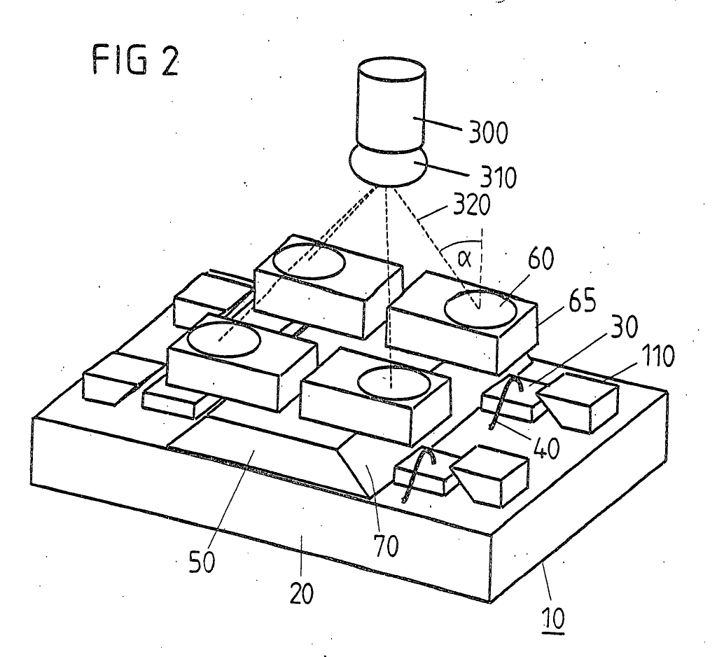

FIG. 2 shows the exemplary embodiment according to FIG. 1, the electrooptical module being coupled to an optical waveguide by means of an additional lens,

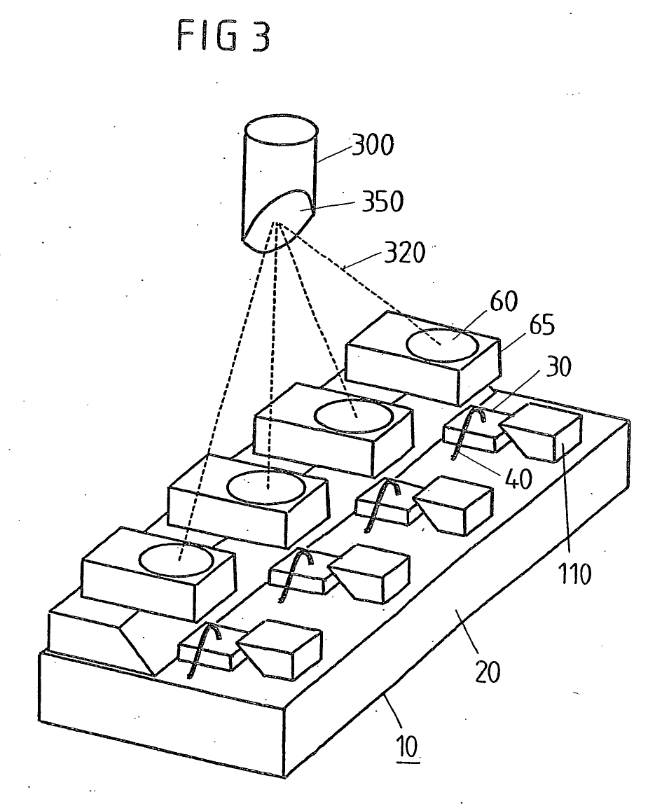

FIG. 3 shows a further exemplary embodiment of an electrooptical module according to the invention, the module being connected to an optical waveguide without an additional lens,

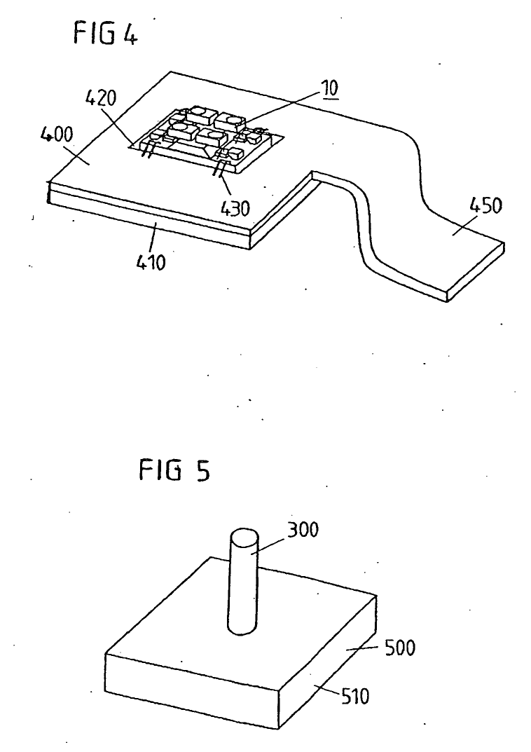

FIG. 4 shows an exemplary embodiment of the way in which the electrooptical module according to FIG. 1 or FIG. 3 is attached on a printed circuit board,

FIG. 5 shows an exemplary embodiment of a covering cap for attachment of an optical waveguide on an electrooptical module according to the invention and

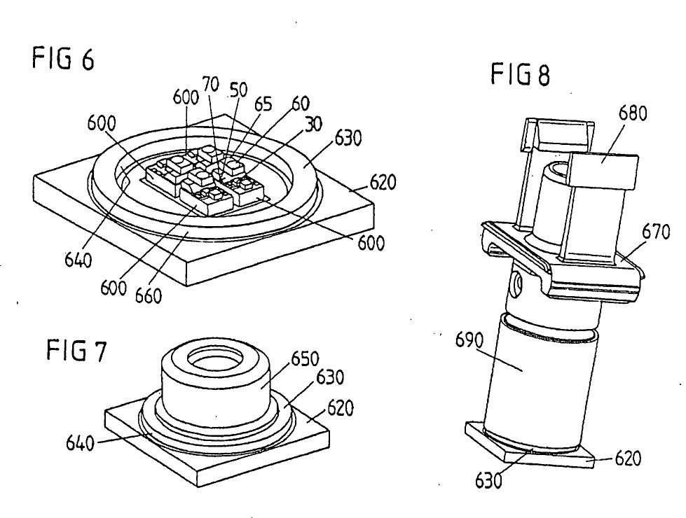

FIGS. 6-8 show a third exemplary embodiment of an electrooptical module according to the invention with an adjusting ring.

In the figures, the same designations are used for identical or comparable components.

In FIG. 1 there can be seen an electrooptical module 10, which has a substrate 20. The substrate 20 may be, for example, a silicon substrate. Arranged on the substrate 20 are four edge-emitting lasers 30, which are respectively connected by a bonding wire 40 to conductor tracks of the substrate 20, which are not represented in FIG. 1. The substrate 20 consequently performs the function of a carrier plate or a carrier and could consequently also be referred to as a “submount” or “baseplate”.

In FIG. 1 there can also be seen a supporting element 50, on which four optical lenses 60 are arranged. The optical lenses 60 are in this case attached by means of their lens carriers 65 to the edge of the supporting element 50 in such a way that the optically active part of the lenses 60 protrudes beyond the lateral edge of the supporting element 50.

The supporting element 50 is reflectively coated on its outer sides 70 facing the lasers 30, so that the light emerging from the lasers 30 is reflected at the reflectively coated outer sides 70 and sent back in the direction of the optical lenses 60. The optical path of rays between the edge-emitting laser 30 and the optical lenses 60 is represented by way of example by dashed lines 100.

Additionally arranged on the substrate 20 are four monitor diodes 110. Each of the four monitor diodes 110 is respectively assigned to a laser 30, to be precise in such a way that the laser light radiated by the respective edge-emitting laser 30 in the direction of the monitor diode 110 is received by the monitor diode. In dependence on the respectively received laser light, the monitor diodes 110 respectively produce a monitor signal, which is transmitted to an evaluation circuit (not represented in FIG. 1), which performs the driving of the edge-emitting lasers 30.

The optical lenses 60 may be of such a kind that the light produced by the edge-emitting lasers 30 falls onto a window cap of a TO package (not represented in FIG. 1). In the case of such an arrangement, the connection of the electrooptical module 10 to an optical waveguide would take place by the optical waveguide being optically adjusted in relation to the window cap of the TO package.

FIGS. 2 and 3 show the actual form that may be taken by the adjustment of the electrooptical module 10 to an optical waveguide.

In FIG. 2, the electrooptical module 10 according to FIG. 1 can be seen, and also an optical waveguide 300, which is in optical connection with the electrooptical module 10 by means of an additional lens 310.

The optical connection between the optical waveguide 300 and the additional lens 310 on the one hand and the edge-emitting lasers 30 on the other hand is brought about by the optical lenses 60, which direct the light of the edge-emitting lasers 30 in the direction of the additional lens 310 and consequently into the optical waveguide 300.

The path of rays between the optical lenses 60 and the additional lens 310 is identified in FIG. 2 by the designation 320. It can be seen that the optical lenses 60 do not bring about “straight” imaging, since the optical axis of the light that is incident on the lenses 60 and the optical axis of the emergent light are not identical or do not coincide. In actual fact, the optical axis of the laser light produced by the edge-emitting lasers 30 and the optical axis of the light emerging from the optical lens 60 have in each case a squint angle α, which is chosen such that the light generated by the lasers 30 can fall onto the optical waveguide 300.

On account of this squint angle a of the optical lenses 60, it is possible that all four edge-emitting lasers 30 of the electrooptical module 10 can feed their light into one and the same optical waveguide 300.

FIG. 2 additionally reveals that the arrangement of the four edge-emitting lasers 30 and the arrangement of the optical lenses 60 is symmetrical, to be precise in such a way that the edge-emitting lasers 30, and consequently the optical lenses 60, lie on the corner points of a virtual square. Each of the edge-emitting lasers 30 and each of the optical lenses 60 consequently has the same distance from the additional lens 310 or from the optical waveguide 300. Consequently, the optical connection between each of the edge-emitting lasers 30 and the optical waveguide 300 is identical.

The electrooptical module 10 according to FIGS. 1 and 2 may be, for example, a C/D-WDM module, that is to say a module with which rays of light of different wavelengths are transmitted in a single optical waveguide 300. This presupposes that the four edge-emitting lasers 30 emit light at different optical wavelengths.

In the case of the arrangement according to FIG. 2, the additional lens 310 is provided for the purpose of focusing the light produced by the edge-emitting lasers 30 and deflected by the optical lenses 60 by the “squint angle” α onto the optical waveguide 300 in such a way that optimal coupling-in is achieved.

In FIG. 3, a further exemplary embodiment of the way in which the light is coupled into the optical waveguide 300 is shown. It can be seen that, in the case of the exemplary embodiment according to FIG. 3, there is no additional lens arranged between the optical waveguide 300 and the optical lenses 60. Optimal coupling-in of the light generated by the lasers 30 is achieved in the case of the exemplary embodiment according to FIG. 3 by the optical waveguide 300 having an oblique end face 350 on its outer side facing the edge-emitting lasers 30.

It can additionally be seen in FIG. 3 that the arrangement of the edge-emitting lasers 30 is different than in the case of the exemplary embodiment according to FIGS. 1 and 2; in actual fact, the edge-emitting lasers 30 are arranged in a row, that is to say not at the corners of a virtual square. Otherwise, the exemplary embodiment according to FIG. 3 corresponds in its basic mode of operation to the exemplary embodiment according to FIGS. 1 and 2.

FIG. 4 shows how an electrooptical module 10 according to FIGS. 1 and 2 or 3 can be mounted on a printed circuit board. In actual fact, a flexible printed circuit board 400, which may for example be configured as a “flexboard”, can be seen in FIG. 4.

The flexible printed circuit board 400 is attached, for example adhesively attached, on a printed circuit board carrier plate 410. The material of the printed circuit board carrier plate 410 is chosen such that optimal heat removal of the waste heat generated by the electrooptical module 10 is achieved. The printed circuit board carrier plate 410 may consist for example of metal, in particular aluminum.

As can be seen in FIG. 4, a rectangular clearance 420 has been punched out in the flexible printed circuit board 400. The electrooptical module 10 according to FIGS. 1 and 2 or 3 has been placed in this clearance 420. The attachment of the electrooptical module 10 takes place in this case through the printed circuit board carrier plate 410, on which the electrooptical module 10 rests.

The electrical connection between the electrooptical module 10 and the flexible printed circuit board 400 takes place by bonding wires 430, which are connected on the one hand to the flexible printed circuit board 400 and on the other hand to conductor tracks arranged on the substrate 20 of the electrooptical module 10.

It can also be seen from FIG. 4 that the flexible printed circuit board 400 does not have to be adhesively attached on or applied to the printed circuit board carrier plate 410 over its entire area; for instance, in FIG. 4 there can be seen a region 450 in which the flexible printed circuit board 400 is not adhesively attached on the printed circuit board carrier plate 410.

In the case of the exemplary embodiment according to FIG. 4, the region 450 of the flexible printed circuit board 400 forms a flexboard connector, with which the flexible printed circuit board 400 can be connected to external plug sockets or the like.

FIG. 5 shows an exemplary embodiment of the way in which the optical waveguide 300 according to FIGS. 2 and 3 is attached.

In FIG. 5 there can be seen a covering cap 500, through which the optical waveguide 300 is led. The optical waveguide 300 may in this case be adhesively fixed in the covering cap 500, in order to achieve a secure connection between the optical waveguide 300 and the covering cap 500.

The adhesive bonding of the optical waveguide 300 additionally achieves the effect that the connection between the optical waveguide and the covering cap provides a hermetic seal. A covering cap like the covering cap 500 can be produced for example by a sheet of silicon (for example a silicon wafer) firstly being micromechanically structured and then isotropically etched in a potassium hydroxide solution. The etching produces a pyramid-step-like depression, the depth of which is chosen in dependence on the structural height of the electrooptical module 10, in particular in dependence on the position of the optical lenses 60. The pyramid-step-like depression is consequently made on the outer side 510 of the covering cap 5 facing the optical lenses 60.

In the center of the groove produced after the etching step, a hole for the optical waveguide 300 is then produced, for example by a laser. Subsequently, the silicon wafer is sawn up, completing the covering cap; the optical waveguide 300 is then adhesively fixed into the finished covering cap. If a silicon wafer is used, it is of course possible for a multiplicity of covering caps to be produced simultaneously.

The covering cap 500 may instead also be an injection-molded part or a multilayer ceramic component, into which the optical waveguide 300 is for example adhesively fixed.

However, a silicon covering cap 500 has the advantage over a plastic injection-molded part or a multilayer ceramic component that the material of the covering cap is adapted to the silicon substrate 20 of the electrooptical module 10. On account of this adaptation, it is possible to place the covering cap 500 directly onto the electrooptical module 10, because the thermal coefficients of expansion are identical, and consequently no thermal material stresses can occur.

The mounting of the covering cap 500 on the electrooptical module 10 may take place in such a way that the covering cap 500 is placed onto the electrooptical module, actively adjusted and then securely fixed by adhesive. A UV-curing adhesive may be used for example for the adhesive bonding, since particularly rapid curing is achieved with this adhesive.

If the covering cap 500 extends completely over the electrooptical module 10, and consequently covers over the bonding wires 430 and 440, the electrooptical module 10 can be closed off hermetically, or virtually hermetically, by the covering cap 500.

Alternatively, the covering cap 500 may also be dimensioned such that it only covers the inner module region—that is to say the region with the lasers and the lenses—and consequently leaves the electrical terminal pads of the electrooptical module free for the contacting carried out later—for example by bonding. In this case, the covering cap, which is attached on the electrooptical module for example by soldering, must be prevented from causing an electrical short-circuit between the conductor tracks of the electrooptical module. This can be achieved for example by an insulating layer, with which the conductor tracks applied to the substrate 20 are electrically separated from the covering cap 500 or the solder attachment of the covering cap.

To attach the covering cap 500, it may have an outer flange region for the attachment on the substrate 20. Alternatively, the flange region may also be formed by a separate component, which is applied to the substrate 20 and onto which the covering cap 500 is subsequently placed.

An electrooptical module 10 with edge-emitting lasers 30 has been explained in conjunction with FIGS. 1 to 3. Instead of edge-emitting lasers 30, vertically emitting lasers may also be used in the electrooptical module. In such a case, it is possible to dispense with the reflective coating of the outer side 70 of the supporting element 50 facing the lasers.

To adjust the fiber 300 in relation to the optical lenses 60 of the electrooptical module 10, the following procedure is followed:

Firstly, the four optical lenses 60 are actively adjusted such that their focus respectively falls at the same point, to be specific to where the fiber or the optical waveguide 300 is “adjusted” in a later step. In this case, the location and the distance of the focus are to be determined such that maximum coupling-in efficiency into the optical waveguide 300 is later achieved. Subsequently, the optical waveguide 300 is then adjusted.

If the electrooptical module 10 according to FIGS. 1 to 3 is to be used as a WDM module (for example as a C/D-WDM module), the lasers 30 are to be chosen or driven such that they transmit at different wavelengths. Instead of lasers, diodes, for example I-REDS (infrared-emitting diodes), may also be used in the case of the electrooptical module.

In the case of the exemplary embodiment according to FIG. 2, the additional lens 310 is provided on the optical waveguide 300; in the case of the exemplary embodiment according to FIG. 3, the optical waveguide 300 is provided with an oblique end face 350. For the sake of completeness, it should be pointed out that coupling of the light into the optical waveguide 300 is also readily possible without the additional lens 350 and also without the oblique end face 350; the light of the lasers 30 can consequently also be coupled into the optical waveguide 300 directly from the lenses 60.

In FIGS. 6 to 8, a third exemplary embodiment of an electrooptical module according to the invention is shown. The module has four separate micro-modules 600 (cf. FIG. 6). Each micro-module 600 is respectively equipped with a laser 30, which is arranged on an auxiliary carrier 610. Each laser 30 is respectively assigned a supporting element 50, on which a lens 60 is arranged in each case. Each optical lens 60 is respectively attached by means of a lens carrier 65 to the edge of the assigned supporting element 50 in such a way that the optically active part of the lenses 60 protrudes beyond the lateral edge of the supporting element 50.

The supporting elements 50 are reflectively coated on their outer sides 70 facing the lasers 30, so that the light emerging from the lasers 30 is reflected at the reflectively coated outer sides 70 and sent back in the direction of the optical lenses 60. The micro-modules 600 consequently correspond in their construction to the arrangement according to FIG. 1; all that is different is that the lasers 30 are respectively arranged on a separate auxiliary carrier 610 and not directly on a common carrier (cf. FIG. 1).

As FIG. 6 reveals, the four micro-modules 600 are arranged symmetrically on a common ceramic carrier 620, to be precise in such a way that the lenses 60 lie on the corner points of an imaginary quadrilateral, in particular a rectangle or a square. The arrangement of the micro-modules 600 is in this case chosen in such a way that the emerging light of the four lasers 30 meets at a common point; this common point forms the coupling point for the connection to a common optical waveguide (cf. FIGS. 2 and 3).

The four micro-modules 600 are surrounded by an adjusting ring 630, the ring center point of which lies on the axis of the direction of propagation of the “common” optical waveguide that is to be brought into an optical connection with the four lasers 30.

The function of the adjusting ring 630 is to receive with its inner ring side 640 an upper part 650 of a package, for example a TO package, in a self-centering manner, in such a way that the package lies centrally over the arrangement of the micro-modules 600. This is shown by FIG. 7.

The function of the outer ring side 660 of the adjusting ring 630 is to permit coupling of a connecting element 670, which is formed for example by an “SC receptacle” 680, to a coupling ring 690 (cf. FIG. 8). For this purpose, the connecting element 670 is placed onto the adjusting ring 630; in the process, the coupling ring 690 is slipped over the upper part 650 of the package. This consequently achieves automatic adjustment between the adjusting ring 630 and the connecting element 670 and, as an accompanying effect, automatic adjustment between the four micro-modules 600 and the connecting element 670

List of designations

10 Electrooptical module

20 Substrate

30 Laser

40 Bonding wires

50 Supporting element

60 Optical lenses

65 Lens carrier

70 Outer side

100 Dashed lines

110 Monitor diodes

300 Optical waveguide

310 Additional lens

320 Path of rays

350 Oblique end face

400 Flexible printed circuit board

410 Printed circuit board carrier plate

420 Clearance

430 Bonding wires

450 Flexboard connector

500 Covering cap

510 Inner side of the covering cap

600 Micro-module

610 Auxiliary carrier

620 Ceramic carrier

630 Adjusting ring

640 Inner ring side

650 Upper part of a package

660 Outer ring side

670 Connecting element

680 SC receptacle

690 Coupling ring

1. An electrooptical module, comprising least two electrooptical components operably coupled to at least one optical waveguide, wherein the at least two electrooptical components each are in an optical free-beam connection with the same waveguide by means of at least one lens.

2. The electrooptical module as claimed in claim 1, wherein at least one of the lenses comprises an optical squint angle.

3. The electrooptical module as claimed in claim 1, wherein the at least two electrooptical components are arranged symmetrically with respect to their coupling to the optical waveguide, and the lenses of the at least two electrooptical components respectively have the same optical squint angle.

4. The electrooptical module as claimed in claim 1, wherein the electrooptical components are arranged on a common carrier.

5. The electrooptical module as claimed in claim 4, wherein the lenses are arranged in such a way on a supporting element, or a respective supporting element, that is located on the carrier such that the lenses are located spatially over a portion of the respective electrooptical components.

6. The electrooptical module as claimed in one of the claim 1, wherein the electrooptical components are respectively arranged on an individual auxiliary carrier and the individual auxiliary carriers are arranged on a common carrier.

7. The electrooptical module as claimed in claim 6, wherein the lenses are respectively arranged on a supporting element that is located on the respective auxiliary carrier in such a way that the lenses are located spatially over a portion of the respective electrooptical components assigned to them.

8. The electrooptical module as claimed in claim 1, wherein the at least two electrooptical components comprise lasers or light-emitting diodes.

9. The electrooptical module as claimed in claim 8, wherein the lasers or light-emitting diodes emit light at different wavelengths.

10. The electrooptical module as claimed in claim 8, wherein the electrooptical module is comprises a C- or D-WDM module.

11. The electrooptical module as claimed in claim 1, wherein the electrooptic components comprise four lasers or four light-emitting diodes that are assigned to the same optical waveguide, the lasers or the light-emitting diodes being arranged symmetrically with respect to the waveguide.

12. The electrooptical module as claimed in claim 11, wherein the four lasers lie on corner points of a virtual or imaginary square, and wherein the optical waveguide is located at a center point of the imaginary square.

13. The electrooptical module as claimed in one of claim 1, wherein the electrooptical components comprise lasers, and wherein the lasers are arranged in a row.

14. The electrooptical module as claimed in claim 1, wherein at least one of the at least two electrooptical components comprises an edge-emitting laser and the supporting element is reflectively coated on its outer side or outer sides assigned to the laser or the lasers, the supporting element and the reflectively coated outer side or sides being arranged in such a way that they direct the light emitted by the laser or by the lasers onto the respectively assigned lens.

15. The electrooptical module as claimed in claim 1, wherein the electrooptical module is accommodated in a TO package and the lenses are optically adjusted respectively with respect to the window cap of the TO package.

16. The electrooptical module as claimed in claim 1, wherein the electrooptical module is mounted on a ceramic substrate or a flexible printed circuit board.

17. The electrooptical module as claimed in claim 16, wherein the flexible printed circuit board is adhesively attached on a printed circuit board carrier.

18. The electrooptical module as claimed in claim 17, wherein the printed circuit board carrier comprises a metal.

19. The electrooptical module as claimed in claim 16, wherein the electrooptical module is connected by bonding wires to the flexible printed circuit board.

20. The electrooptical module as claimed in claim 1, wherein the electrooptical module comprises at least one optical plug-in device for the connection to the at least one optical waveguide.

21. The electrooptical module as claimed in claim 1, wherein the at least one optical waveguide is led through a covering cap, with which the electrooptical module is hermetically sealed.

22. The electrooptical module as claimed in claim 21, wherein the covering cap and the electrooptical module are designed in such a way that an optical adjustment between the optical waveguide and the lenses takes place by an adjustment of the covering cap in relation to the lenses.

23. The electrooptical module as claimed in claim 1, wherein an additional lens is arranged directly on the at least one optical waveguide and is used to couple the light of the electrooptical components into the optical waveguide.

24. The electrooptical module as claimed in claim 1, wherein the at least one optical waveguide has an oblique end face, into which the light of the electrooptical components is coupled.

25. The electrooptical module as claimed in claim 1, wherein the at least one optical waveguide comprises an end face which is arranged perpendicular to a direction of propagation of the light and is in an optical free-beam connection with the lenses.

26. The electrooptical module as claimed in claim 1, wherein an adjusting ring is present, the center point of which lies on an axis of the optical waveguide.
